(19) United States
(12) Patent Application Publication
(10) Pub. No.: US 2021/0331496 A1
(43) Pub. Date: Oct. 28, 2021

(54) CUTTER MODULE AND METHOD

(71) Applicant: HEWLETT-PACKARD DEVELOPMENT COMPANY, L.P., Spring, TX (US)

(72) Inventors: Felix Ruiz Martinez, Sant Cugat del Valles (ES); Martin Urrutia Nebreda, Sant Cugat del Valles (ES); Daniel Hernandez, Sant Cugat del Valles (ES)

(21) Appl. No.: 16/605,597

(22) PCT Filed: Apr. 25, 2018
(86) PCT No.: PCT/US2018/029276

§ 371 Date: Oct. 16, 2019

(51) Int. Cl. B41J 11/68

(52) U.S. Cl. CPC B41J 11/68

(57) ABSTRACT

A cutter module comprises an active rotary cutting blade driven by a blade drive, a passive cutting blade opposite the active rotary cutting blade, and a traction mechanism to pinch a medium to be cut in an area adjacent to the active rotary cutting blade and the passive cutting blade.

### BACKGROUND

Some printers include a cutting device which can cut a print medium before or after a printing operation. The cutting device may include a cutting blade supported on a carriage to move across a print zone. By movement of the carriage across the print zone and/or movement of the print medium along a media advance path through the print zone, the cutting blade may cut in one or two linear directions, such as the X and Y directions.

### BRIEF DESCRIPTION OF DRAWINGS

The following description references the drawings, wherein

FIG. 1 shows a perspective view of a cutting arrangement including a cutter module according to an example;

FIG. 2 shows a perspective view of the cutting arrangement of FIG. 1 in combination with printer parts according to an example;

FIG. 3 shows a perspective view of a part of the cutting arrangement including two cutter modules according to an example, with parts broken away;

FIG. 4 shows a different perspective view of the cutting arrangement and cutter modules shown in FIG. 3;

FIG. 5A shows a perspective view of a cutter module according to an example;

FIG. 5B shows a similar perspective view of a cutter module, according to an example, with parts broken away;

FIG. 6A shows a front view of a cutter module according to an example;

FIG. 6B shows an enlarged detail of the cutter module of FIG. 6A, according to an example;

FIG. 7A shows an exploded view of parts of a cutter module according to an example;

FIG. 7B shows an enlarged detail of the cutter module of FIG. 7A, according to an example;

FIG. 8 shows a flow diagram of a media cutting method according to an example.

### DETAILED DESCRIPTION

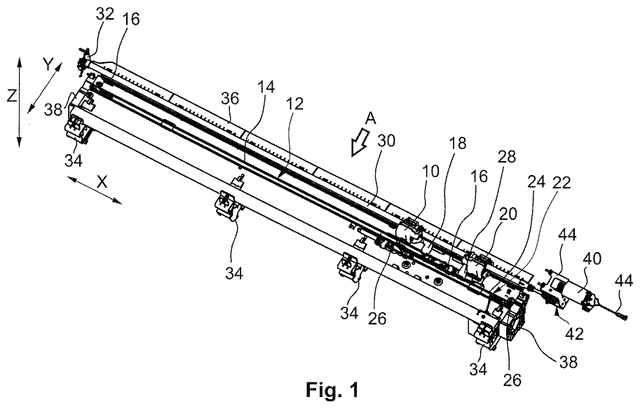

FIG. 1 to 4 provide an overview to illustrate a cutting arrangement using two cutter modules according to an example, in different perspective views.

In the illustrated example, the cutting arrangement comprises a first cutter module 10 and a second cutter module 20, which are discussed in further detail below. The first and second cutter modules 10, 20 are arranged on a shaft 30 extending in a direction perpendicular to a media advance direction of a printer which is illustrated by arrow A. The media advance direction A also is referred to as Y direction, and a carriage scanning direction, perpendicular to the Y direction, also is referred to as X direction. The direction of gravity, perpendicular to both the Y and X directions, may be designated as Z direction. The first cutter module 10 also can be designated as left-hand cutter module, and the second cutter module 20 also can be designated as right-hand cutter module, wherein left and right designates the position of the cutter module as seen from the front of the printer which, in this example, is the direction opposite to the media advance direction A.

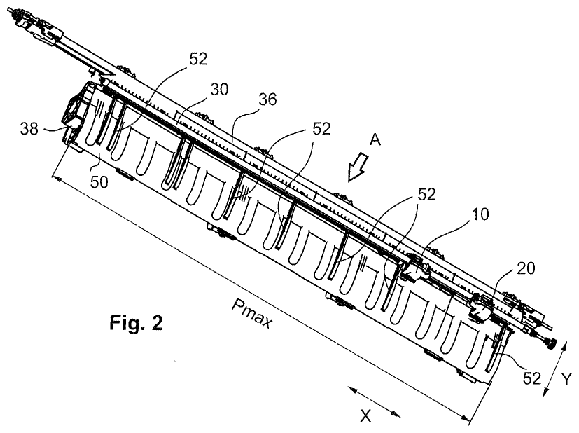

The two cutter modules 10, 20 are arranged on the shaft 30 to be independently slidable along the length of the shaft 30, e.g., along the scanning direction, wherein sliding movement of the cutter modules 10, 20 can be caused by respective first and second pulley drives 12, 22 coupled to the first and second cutter modules 10, 20 via positioners 18, 28. This allows selectively positioning the two cutter modules 10, 20 at a right-hand edge and a left-hand edge of a cutting zone downstream of a print zone of the printer, for different cutting zones of varying width and position. In the illustrated example, a cutting zone of maximum width Pmax would extend about across the width of an output platen 50, illustrated in FIG. 2. Each pulley drive 12, 22 comprises a pulley belt 14, 24 and pulley wheels 16, 26 and drive units (not shown) for driving at least one of the pulley wheels 16, 26 of each pulley drive. A drive unit may comprise e.g. an electric motor.

In the illustrated example, pulley drive 22 associated with the second or right-hand cutter module 20 extends across about 30% of the maximum cutting zone width Pmax, at the right-hand side of the cutting zone, and pulley drive 12 associated with the first or left-hand cutter module 10 extends across about 80-90% of the maximum cutting zone width Pmax, at the left-hand side of the cutting zone. The belts 14, 24 of the first and second pulley drives 12, 22 overlap and, for example, can be designed in such a way that the first and second cutter modules 10, 20 can be positioned at any left-hand and right-hand margins of a print medium which the associate printer is able to print on in the print zone.

The first and second cutter modules 10, 20 are removably coupled to the first and second pulley belts 12, 24 by respective positioners 18, 28 to be engaged with the cutter modules 10, 20. Accordingly, movement of either one of the belts 14, 24 pulls the associated cutter module 10, 20 along the shaft 30 to position the cutter modules 10, 20 on two sides of an adjustable cutting zone, for example.

The shaft 30 is coupled to a drive motor 40 via a drive gear train 42, including a number of gears, for transmitting rotation of the drive motor 40 to the shaft 30. The drive motor 40 may be a BLDC motor or a stepping motor or another electric motor. The drive motor 40 may be supplied and driven via supply/drive lines 44 operatively coupled to a controller (not shown) of the printer, for example.

The cutter arrangement including the drive motor 40 may be mounted in a printer chassis (not shown) via a number of brackets and supports 32, 34, 36, 38, 44.

FIG. 2 illustrates an output platen 50 which may serve as support for a print medium which is transported through the printer and out of a print zone in the media advance direction A. the output platen 50 covers the pulley drives 12, 22 and the positioners 18, 28 to guide the print medium on a smooth surface of the output platen 50. The cutter modules 10, 20 will be arranged above the output platen. FIG. 2 further shows a number of retractable ribs 52 which are provided for supporting the print medium to stay flat and even when transported in the media advance direction A. A print media advance system (not shown) may be provided to transport the print medium through the print zone and across the output platen 50 in a media advance direction A.

Further, a print head (not shown) may be arranged above the print zone upstream of the output platen 50 to deposit a printing fluid on the print medium within the print zone. The print head or several print heads may be carried by a printer carriage which may be slidable along a bar or a shaft (not shown) parallel to shaft 30 and extending in a direction perpendicular to the media advance direction A. The carriage may carry an array of print heads containing printing fluids, e.g. four, MCYK, ink inkjet print heads. The printing fluid may be dispensed from the print heads which may be any fluid that can be dispensed by an inkjet-type printer or other inkjet-type dispenser and may include inks, varnishes, and/or post or pre-treatment agents, for example. The carriage scans across the print medium in the print zone while the print heads are selectively fired to generate a printed plot.

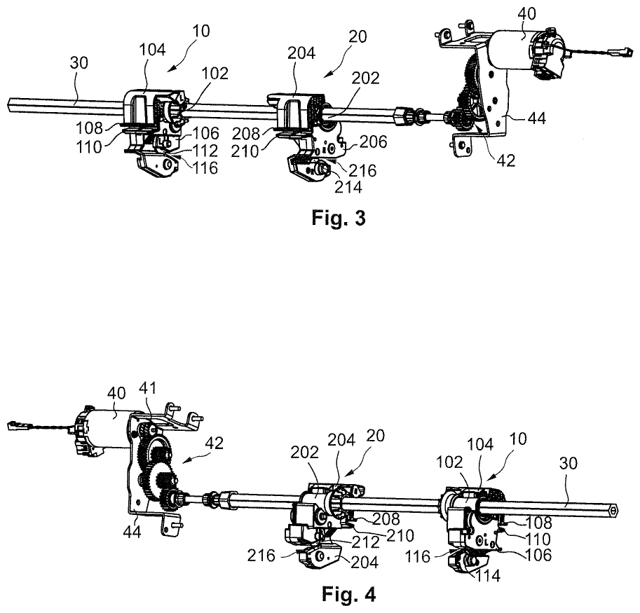

FIGS. 3 and 4 show further details of the drive gear train 42, coupling the drive motor 40 to the shaft 30, and of the coupling mechanism between the drive shaft 30 and the first and second cutter modules 10, 20. FIG. 3 is a perspective view from a similar angle as FIG. 1, and FIG. 4 is a perspective view from the opposite side of FIG. 3. The same or corresponding components as in the previous figures are designated by the same reference numbers.

In the illustrated example, the drive gear train 42 comprises a number of spur gears which, in the example, provide three transmission stages to transmit rotation of a toothed output shaft 41 of the drive motor 40 to shaft 30. The drive gear train 42 allows adjusting the rotation speed of the shaft 30 and transmits rotation of output shaft 41 in both a clockwise direction and a counterclockwise direction.

In the illustrated example, the shaft 30 has a polygonal cross-section, such as a hexagonal cross-section wherein other cross-sections, including a circular or noncircular, elliptic or a non-symmetrically shaped cross-section may be provided. The cutter modules 10, 20 are coupled to the shaft 30 by respective transmission rings 102, 202. In the example, the transmission rings 102, 202 engage with the outer periphery of the shaft 30 in a formfitting manner wherein, alternatively or additionally, a press fit or engagement by additional fixing elements, such as a screw, a bracket, adhesive or the like may be provided.

In the illustrated example, each cutter module 10, 20 comprises an upper module half 104, 204 and a lower module half 106, 206 which clamp the respective transmission ring 102, 202. Handle-like extensions 108, 110, 208, 210 are provided at the upper and lower module halves 104, 204 to be grabbed and pressed against each other to pivot the upper and lower module halves 108, 110, 208, 210 relative to each other to disengage the module halves from the transmission rings and unlatch the respective cutter modules 10, 20 from the transmission rings 102, 202. Accordingly, each cutter module 10, 20 can be replaced by pressing together the-handle-like extensions 108, 110, 208, 210, unlatching the cutter modules 10, 20 from the transmission rings 102, 202 and inserting another cutter module by the reverse operation.

In the example illustrated, each of the cutter modules 10, 20 comprises an upper rotary cutting blade 112, 212 and a lower rotary cutting blade 14, 24, which may be better recognized in the following drawings. The upper rotary cutting blade 112, 212 is an example of an active cutting blade and the lower rotary cutting blade 14, 24 is an example of a passive cutting blade. The respective upper rotary cutting blades 112, 212 are movable cutting blades which are driven to rotate by rotation of the shaft 30, via a respective transmission group provided in the respective cutter module 10, 20. Each transmission group may have an adjustable transmission ratio. In the example, the lower rotary cutting blade 14, 24 may be in contact with the upper rotary cutting blade 112, 212 to be friction-driven by the upper rotary cutting blade and to cut a print medium there between.

In another example, instead of providing a lower rotary cutting blade, a lower stationery blade may be provided, such as a knife like linear blade, which interacts with the upper rotary cutting blade 112, 212 to cut a print medium there between. The lower stationery blade is another example of a passive cutting blade. In another example, the upper rotary cutting blade 112, 212 may interact with a counter surface, instead of a lower cutting blade, to cut the print medium transported across the counter surface.

In the examples, each of the cutter modules 10, 20 comprises a gap 116, 216 to guide a print medium there between and towards the associated cutting blades 112, 114, 212, 214.

When cutting thin media of low rigidity, the material could cause a jam in the gap 116 and may suffer scratches if the media is not transported sufficiently flat and tensioned relative to the cutter modules. This is particularly noticeable if the media material expands with ink deposition and increased humidity. Therefore, the cutter modules include a traction mechanism to pinch a medium to be cut in the gap area adjacent to the upper rotary cutting blade and the lower cutting blade. For example, by providing a contact surface associated with and adjacent the upper rotary cutting blade and a counter surface associated with and adjacent the lower rotary cutting blade, the cutter module has traction capacity wherein the medium to be cut is pinched between the contact surface and the counter surface. Additionally this media expansion could also affect the shape of the media in the print zone. If the media expansion is not absorbed by the cutter modules, a bubble of media may appear under the pen carriage and the printheads may scratch the upper surface of the printing media.

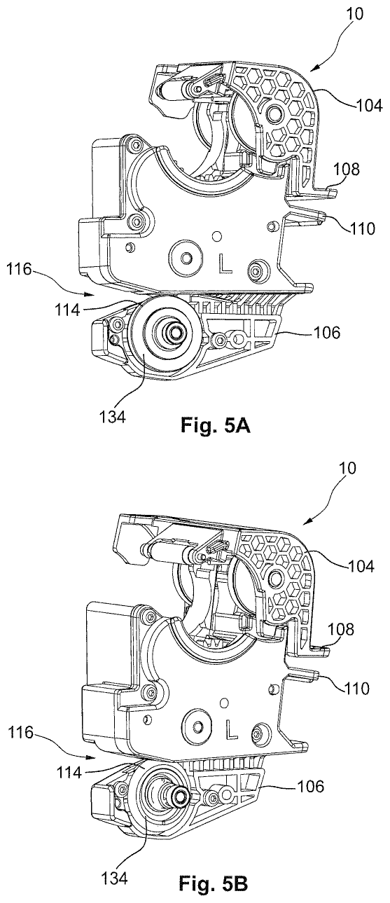

FIGS. 5A, 5B, 6A, 6B, 7A, and 7B show different views of a cutter module according to an example, or parts thereof, to illustrate an example of the traction mechanism. Reference is made to the above description of FIG. 1 to 4 wherein the same reference numbers designate same or corresponding features. The drawings show a left-hand cutter module 10, with the right hand cutter module being configured in a similar way. The right-hand module 20 and the left-hand module 10 may be mirror versions of each other or may include variations.

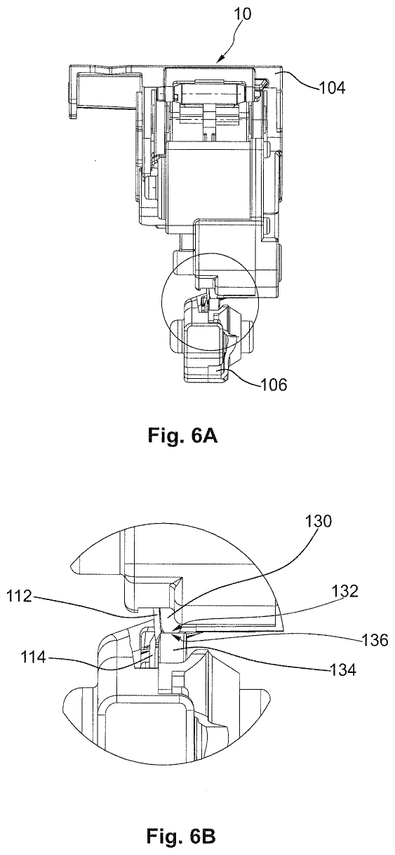

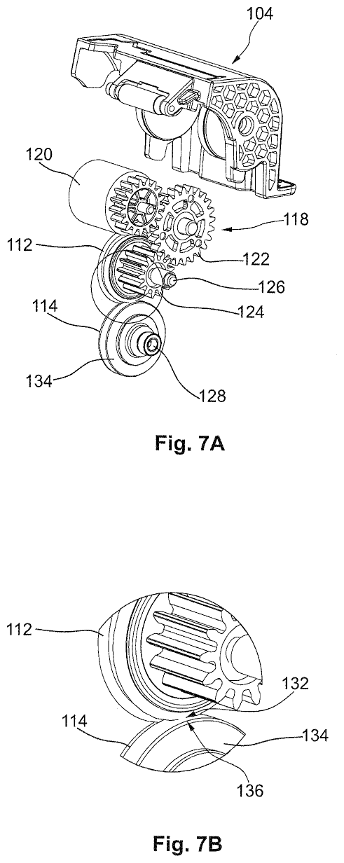

The cutter module 10 shown in the drawings comprises upper and lower module halves 104, 106, the upper module half 104 rotatably supporting the upper rotary cutting blade 112 (best seen in FIGS. 6B and 7B) on an associated shaft 126 and the lower module half 106 rotatably supporting the lower rotary cutting blade 114 on an associated shaft 128, the cutting blades located on opposite sides of the gap 116. In an example, the upper cutting blade 112 may be an active driven cutting blade and the lower cutting blade 114 may be a passive cutting blade because it may not be actively driven by an associated drive mechanism in contrast with the upper cutting blade 112.

Adjacent to and coaxial with the upper rotary cutting blade 114, a ring-shaped disc carrying an O ring 130 is provided. The peripheral surface of the disk and/or of the O ring 130 features a contact surface 132. Adjacent to the lower rotary cutting blade 116 a counter body 134 is provided wherein the counter body has a cylindrical outer face which features a counter surface 136. The contact surface 132 and the counter surface 136 can be used to pinch a medium to be cut there between so that the cutter module 10, in addition to cutting the medium, has traction capacity and can hold and pull the medium which is trapped between the contact surface 2 and the counter surface 136. Accordingly, the medium can be transported by the cutter module 10 during cutting. Additionally, if a right hand cutter module and a left-hand cutter module having the same type of traction capacity are provided, the medium can be tensioned between the two cutter modules to obtain a clean cut.

One or both of the contact surface 132 and the counter surface 136 may be made of or provided with an elastomeric surface. For example, an elastomeric O ring 130 may be arranged adjacent to the upper rotary cutting blade to provide an elastomeric contact surface 132. Elastomeric surface(s) enhance friction between the contact and counter surfaces 132, 136 and the medium to be cut.

The counter surface 136 provided at the lower rotary cutting blade 114 may be biased against the contact surface. For example, the counter body 134 may be shaped as a hollow cylinder or a hollow cup, wherein an interior face of the hollow cylinder is supported on a shaft 128 of the passive cutting blade 114 via a spring 140, illustrated in FIG. 5B, in which the counter body 134 is not illustrated. For example, if the counter body 134 is shaped as a hollow cylindrical cup, the cylinder axis is extending perpendicularly to the shaft 128 of the lower cutting blade 114, and the peripheral surface of the cylindrical cup, forming the counter surface 136, is pushed upwards towards the contact surface 132 associated with the upper rotary cutting blade 112, by the spring 140 generating a biasing force between the shaft 128 and the interior face of the cylindrical cup. The spring 140 may comprise a torsion spring. Biasing the counter surface 136 against the contact surface 132 increases traction force and provides an approximately constant force between the contact and counter surfaces 132, 136, independent of wear of mechanical parts of the cutter modules 10, 20 and of the thickness of the medium to be cut. Furthermore, biasing the counter surface 136 provides the cutter with the ability to cut while applying a tension and traction force on media of several thicknesses.

In an alternative example, not shown in the drawings, the passive or lower cutting blade may be a linear cutting blade, associated with a counter body which is arranged adjacent to the lower cutting blade, the counter body having a plane outer face providing a counter surface. The counter body may include a spring or other device to bias the counter surface against the contact surface 132 associated with the upper rotary cutting blade 112. As in the previous example, the counter surface may feature an elastomeric surface to enhance friction between the counter surface and a medium to be cut to reliably pinch and grab the medium between the counter surface and the contact surface 132.

FIG. 7A additionally illustrates a transmission group 118 which is provided between the shaft 30 and the upper rotary cutting blade 112 to drive the upper rotary cutting blade 112 by rotation of the shaft 30. The transmission group 118 comprises a number of gears 120, 122, 124 wherein a first gear 120 comprises a cylindrical body which engages with the surface of the transmission ring 102 to transmit rotation of the shaft 30 the first gear 120. The first gear 120 meshes with a second gear 122 which in turn meshes with a third gear 124. The third gear 124 is supported on a common rotary shaft 126 which also carries the upper rotary cutting blade 112. Accordingly, the upper rotary cutting blade 112 and its associated contact surface 132 are driven by rotation of the shaft 30 via the transmission group 118. The lower rotary cutting blade 114 is supported by its associated shaft 128 supported in the lower module half 106. The lower rotary cutting blade 114 and its associated contact surface 136 may be driven by the upper rotary cutting blade 112 by friction contact between the two blades 11, 114. Drive of the upper active rotary cutting blade by rotation of the shaft is just an example and other ways of driving the rotary cutting blade(s) are possible.

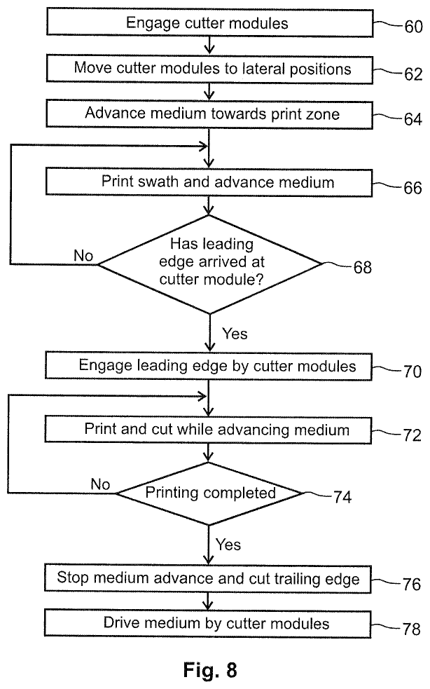

FIG. 8 shows a flow diagram of a media cutting process according to an example. The process may be performed in a printer, such as an inkjet printer, including a cutter arrangement having two cutter modules 10, 20. The process comprises engaging the cutter modules 10, 20 and the shaft, at block 60, and moving the cutter modules 10, 20 along the shaft 30 to desired lateral positions at the two sides of printing and cutting zones, at block 62. The cutter modules 10, 20 can be arranged at a distance corresponding to a to-be-cut width of a print medium. The print medium then is advanced towards a print zone of the printer, at block 64, with a leading edge of the print medium crossing the print zone in the media advance direction A. The print medium (not shown in the drawings) can be a print medium, such as a single sheet or a continuous web of print medium fed to the print zone from an input tray, a drawer or roll of paper, for example. The medium may be paper or a foil, for example. The print medium can be fed by media feed rollers which are arranged downstream and/or upstream of the print zone, by a belt or a number of belts and/or by rollers integrated into the print platen, for example.

Once the print medium has arrived at the print zone, the printer can start printing swaths of a print fluid, such as ink, and advancing the medium through the print zone, at block 66. At block 68 it is checked, whether the leading edge of the print medium has arrived at the cutter modules 10, 20. If no, the printer continues to print swaths of the print fluid and advance the print medium in the media advance direction, at block 66. If the leading edge of the print medium has arrived at the cutter modules, the leading edge of the print medium can be engaged by the cutter modules 10, 20 at two opposite sides of the print zone, at block 70, and the process can continue with printing on and cutting the print medium while advancing the printing medium, at block 72.

The leading edge of the print medium can enter the gaps 116, 216, near side edges of the print medium, to come into contact with the cutting blades 112, 114, 212, 214. At the same time, the print medium also will be engaged between the contact surface 132 associated with the upper rotary cutting blade 112 and the counter surface 136 associated with the lower rotary cutting blade 114. At this point in the process, the cutting blades start cutting into the print medium. During the cutting process, the upper cutting blade 112 is rotated by rotation of the shaft 30 and rotation is transmitted to the lower cutting blade 114 by friction between the two cutting blades 112, 114. Accordingly, also the contact surface 132 and the counter surface 136 rotate together with their associated cutting blades 112, 114 so that the print medium is pinched and transported between the two surfaces 132, 136.

If the circumferential speed of the rotary cutting blades 112, 114, 212, 214 is higher than the media advance speed, rotation of the rotary cutting blades 112, 114, 212, 214 and the respective contact and counter surfaces 132, 136 can create a tensioning effect which pulls the print medium in the media advance direction so that the print medium is held flat and tensioned, improving the cutting performance. Concurrent with the cutting operation 64, printing on the print medium may be performed.

The cutting blades and the associated contact and counter surfaces 132, 136 may be aligned to a direction parallel or substantially parallel to the media advance direction A. The cutting blades and the associated contact and counter surfaces 132, 136 alternatively may be aligned to a direction which includes a small angle with the media advance direction A, such as an angle of about 0.5° to 5° to the media advance direction A. Accordingly, when the cutting blades rotate, due to their slightly oblique arrangement, the cutter modules pull the medium in the media advance direction A but also apply a small pulling component towards the outside of the plot in the scanning direction X. The cutting blades and the associated contact and counter surfaces 132, 136 are arranged in such a manner that the left-hand cutter module 10 pulls to the left and the right hand cutter module 20 pulls to the right, as seen from the front of the printer. This tensions the medium to be cut and removes bubbles of the medium between both cutter modules.

The print medium continues to be advanced in the media advance direction A, with continued printing and cutting operations, as long as the printing process is not completed. Printing on the print medium in the print zone and cutting the two opposite side edges of the print medium in the media advance direction can be performed simultaneously in what may be considered a single operation. It also can be performed intermittently.

At block 74, it is checked whether printing is completed. If yes, the advance of the print medium can be interrupted and a trailing edge of the print medium can be cut in a direction traversing the media advance, i.e. in the X direction, at block 76.

Advance of the print medium then can continue by the engagement of the print medium between the contact surface 132 and the counter surface 136, which continue to be driven together with the upper and lower rotary cutting blades 112, 114, at block 78. This is possible in spite of the print medium having been cut in the X direction so that the print media advance system of the printer may no longer be able to engage with and advance the print medium. The intrinsic traction capacity of the cutter modules can be used to pull the last portion of the print medium and to finalize cutting in the Y direction as the print medium is transported by the traction force of the contact and counter surfaces 132, 136.

Media advance may be stopped and cutting may be interrupted, at 76, for example, when a defined distance between the cutting blades 112, 114 and the trailing edge of the printed product is reached, such as about 1 or 2 cm away from the trailing edge. Then the trailing edge can be cut and the remaining media transport is effected by the traction capacity of the contact and counter surfaces, finalizing the cutting operation. In an alternative example, when a defined distance between the cutting blades 112, 114 and the trailing edge of the printed product is reached, the medium may be moved back by a defined distance to cut the trailing edge, and then the remaining media transport is effected by the traction capacity of the contact and counter surfaces, finalizing the cutting operation. Either way, the process avoids any cutting marks or imprints generated by the cutter modules in the side margins of the printed product. The process also may avoid generating a strip of waste medium between subsequent prints.

The traction capacity of the cutter modules described herein improves reliability in cutting thin media of low rigidity and additionally improves the ability to cut thick and stiff media. It eliminates the risk of jams and scratches.

Drive of the print media advance system (not shown), the shaft 30 and pulley drives 12, 22 of the cutter modules 10, 20 as well as other entities of the printer and an associated cutting equipment may be controlled by a controller (not shown). The controller can be a microcontroller, ASIC, or other control device, including control devices operating based on hardware or a combination of hardware and software. It can include an integrated memory or communicate with an external memory or both. The same controller or separate controllers may be provided for controlling carriage movement, media advance and the rotary actuator. Different parts of the controller may be located internally or externally to a printer or separate cutting device, in a concentrated or distributed environment.

What is claimed is:

1. A cutter module comprising
an active rotary cutting blade driven by a blade drive,
a passive cutting blade opposite the active rotary cutting blade, and
a traction mechanism to pinch a medium to be cut in an area adjacent to the active rotary cutting blade and the passive cutting blade.

2. The cutter module of claim 1, wherein the traction mechanism comprises:
a contact surface associated with and adjacent to the active rotary cutting blade and
a counter surface associated with and adjacent to the passive cutting blade,
the contact surface and the counter surface to pinch the medium to be cut in a nip between the contact surface and the counter surface.

3. The cutter module of claim 2, wherein at least one of the contact surface and the counter surface includes an elastomeric material.

4. The cutter module of claim 2 comprising a disk adjacent to and coaxial with the active rotary cutting blade, a peripheral surface of the disc providing the contact surface.

5. The cutter module of claim 4, wherein the peripheral surface of the disc carries an elastomeric ring.

6. The cutter module of claim 5, wherein the passive cutting blade is a rotary cutting blade, the cutter module further comprising a counter body adjacent to the passive cutting blade, the counter body having a cylindrical outer face providing the counter surface.

7. The cutter module of claim 6, wherein the passive cutting blade comprises a shaft, and the counter body defines a hollow cylinder, wherein an interior face of the hollow cylinder is supported on the shaft of the passive cutting blade via a spring device.

8. The cutter module of claim 7, wherein the counter body is in the shape of a cylindrical cup, an axis of the cylindrical cup extending parallel to the shaft of the passive cutting blade.

9. The cutter module of claim 7, wherein the spring device comprises a torsion spring, the torsion spring biasing the counter body towards the contact surface.

10. The cutter module of claim 4, wherein the passive cutting blade is a linear cutting blade, the cutter module further comprising a counter body adjacent to the passive cutting blade, the counter body having a plane outer face providing the counter surface.

11. A printer including:
a support of a print medium in a print zone;
a print media advance system to transport the print medium through the print zone in a media advance direction;
a cutter module slidably arranged on a shaft, the shaft extending in a direction perpendicular to the media advance direction of the printer, wherein the cutter module comprises
an active rotary cutting blade driven by rotation of the shaft, and
a passive cutting blade opposite the active cutting blade,
a contact surface associated with and adjacent to the active rotary cutting blade, and
a counter surface associated with and adjacent to the lower cutting blade,
the contact surface and the counter surface to pinch the print medium between the contact surface and the counter surface.

12. The printer of claim 11, including a first cutter module and a second cutter module, both cutter modules separately and slidably arranged on the shaft to position the first and second cutter modules on opposite sides of the print zone.

13. A method including
advancing a print medium towards a print zone of a printer, with a leading edge of the print medium crossing the print zone in a media advance direction;
engaging the leading edge of the print medium between a contact surface and a counter surface of a cutter module at a side of the print zone;
printing on the print medium in the print zone and simultaneously cutting by the cutter module a side edge of the print medium in the media advance direction;
interrupting advance of the print medium and cutting a trailing edge of the print medium in a direction traversing the media advance direction;
continuing advance of the print medium by the engagement of the print medium between the contact surface and the counter surface to transport the print medium out of the print zone.

14. The method of claim 13 wherein the contact surface is associated with a rotary cutting blade, wherein the rotary cutting blade is driven to rotate together with the contact surface and wherein the contact surface, when driven to rotate, rolls on a surface of the print medium to transport the print medium.

15. The method of claim 13, wherein
the engaging comprises engaging the leading edge of the print medium by respective contact surfaces and counter surfaces of two cutter modules at two opposite sides of the print zone; and
the continuing comprises continuing advance of the print medium by the engagement of the print medium between the respective contact surfaces and counter surfaces of the two cutter modules;
wherein the print medium is tensioned between the respective contact surfaces and counter surfaces of the two cutter modules.
